(19) United States
(12) Patent Application Publication
(10) Pub. No.: US 2023/0093447 A1
(43) Pub. Date: Mar. 23, 2023

(54) ROTARY-WING UNMANNED AERIAL VEHICLE

(71) Applicant: BONAVIDE (PTY) LTD, Pretoria (ZA)

(72) Inventor: Andries Hermann Leuschner, Pretoria (ZA)

(21) Appl. No.: 16/625,325

(22) PCT Filed: Jun. 5, 2018
(86) PCT No.: PCT/IB2018/054010

§ 371 Date: Dec. 20, 2019

(30) Foreign Application Priority Data
Jun. 27, 2017 (ZA) 2017/04348

(51) Int. Cl. B64C 39/02; G05D 1/10

(52) U.S. Cl. CPC B64C 39/024; G05D 1/10; B64C 2201/027; B64C 2201/108; B64C 2201/162

(57) ABSTRACT

A rotary wing unmanned aerial vehicle (UAV) includes an elongate body 12 having a top end 14 and a bottom end 16 with a plurality of flat sides extending therebetween and defining an internal cavity 30. An exhaust opening 32 and lift propeller 34 are provided at the bottom end 16 of the body 12. The UAV 10 further includes a pressurizing arrangement in the form of spaced-apart openings in the sides and in the top and complementary propellers mounted therein in order to urge air through the openings into the internal cavity 30. This arrangement provides a compact UAV with high lift capabilities.

### FIELD OF THE INVENTION

This invention relates to a rotary-wing unmanned aerial vehicle.

### BACKGROUND OF THE INVENTION

An unmanned aerial vehicle (UAV), commonly referred to as a drone, is an aircraft without a human pilot aboard. The flight of a UAV is controlled either autonomously by on-board computers or remotely by a human or computerized pilot.

A rotary-wing UAV generates lift by means of at least one propeller. Rotary-wing UAVs are distinct from fixed-wing UAVs, which include fixedly mounted wings that are shaped and dimensioned to generate lift as a result of the UAV's forward airspeed. In the remainder of this specification, the term “UAV” should be interpreted as referring to a rotary-wing UAV.

In many applications, a UAV is required to carry some form of a load (hereinafter referred to as a “payload”). In cases where a UAV is required to carry a payload in confined spaces and/or fit through relatively small openings or passages while carrying the payload, the UAV may be required to have a significant lifting capability relative to its own size and/or mass in order to carry the payload.

To enhance the lifting capability of a UAV, additional propellers and/or more powerful propellers may be added to the UAV. The propellers are typically mounted at spaced apart positions on arms which protrude laterally from a body of the UAV and are rotatable about vertical axes of rotation. The Inventor has found that the addition of such propellers typically increases the horizontal span of the UAV. This may make the UAV unsuitable for use in confined spaces and/or in applications that require the UAV to fit through small openings and/or passages.

The Inventor has identified a need to enhance the lifting capability of a UAV while limiting its horizontal span.

### SUMMARY OF THE INVENTION

In accordance with the invention, there is provided a rotary-wing unmanned aerial vehicle (UAV) including:
a body having an operative top and an operative bottom, the body defining an internal cavity;
an exhaust arrangement provided at or near the bottom, the exhaust arrangement including an operatively downwardly open exhaust opening in fluid communication with the internal cavity and a lift propeller configured to urge air out of the internal cavity via the exhaust opening;
a pressurising arrangement including an inlet leading into the cavity and at least one auxiliary propeller, the auxiliary propeller configured to urge air through the inlet into the internal cavity in order to increase air pressure in the internal cavity; and
a drive arrangement for driving the propellers.

Preferably, the pressurising arrangement is located operatively above the exhaust arrangement.

The body may define a longitudinal or operatively vertical axis and a transverse or operatively horizontal axis. The lift propeller or propellers may be configured to rotate about the longitudinal axis or an axis in a plane substantially parallel to the longitudinal axis.

The lift propeller may be mounted to the bottom of the body.

The exhaust opening may be generally circular, with the lift propeller being located in the exhaust opening or mounted to the body by a mounting arrangement located in the exhaust opening. The axis about which the lift propeller is configured to rotate may extend through a center point of the exhaust opening. The lift propeller may have a blade diameter that is slightly smaller than a diameter of the exhaust opening.

The UAV may include a plurality of lift propellers. The lift propellers may be arranged for rotation about a common axis of rotation.

The pressurising arrangement may include a plurality of auxiliary propellers.

Each auxiliary propeller may be located in, or mounted to a mounting arrangement located in, a corresponding inlet of the body which is in fluid communication with the internal cavity. Each auxiliary propeller may be configured to urge air into the internal cavity via the corresponding inlet.

At least one of the auxiliary propellers may be mounted to a side of the body and may be configured to rotate about the transverse axis or an axis in a plane substantially parallel to the transverse axis. At least one of the auxiliary propellers may be mounted to the top of the body and may be configured to rotate about the longitudinal axis or an axis in a plane substantially parallel to the longitudinal axis.

The auxiliary opening may be generally circular. The axis about which the auxiliary propeller is configured to rotate may extend through a center point of the auxiliary opening. The auxiliary propeller may have a blade diameter that is slightly smaller than a diameter of the auxiliary opening.

In some embodiments, the body may have a substantially flat top and bottom and a plurality of substantially flat sides. The auxiliary openings may be provided in the sides and/or the top of the body. The body may substantially have the shape of a polygon. In one embodiment of the invention, the body is in the shape of a hexagonal prism.

Each side of the body may be provided with two auxiliary propellers. The auxiliary propellers of each side of the body may be spaced apart along the longitudinal axis.

The at least one auxiliary propeller may be configured to provide directional control of the UAV, in use. The at least one auxiliary propeller may be configured to generate operative horizontal motion, tilt and/or angular displacement of the UAV. In some embodiments, angular displacement of the UAV about the longitudinal axis may be provided through control of the lift propeller and an auxiliary propeller mounted to the top end of the body.

The lift propeller and the at least one auxiliary propeller may be configured to be operated separately or in one or more groups.

The UAV may be provided with one or more sensors, e.g. LIDAR sensor, motion sensor, gyroscope, accelerometer, inertial measurement unit (IMU) and/or thermal sensor. The UAV may be provided with a Global Positioning System (GPS) module.

The UAV may include a control unit configured to control operation of the lift propeller and the auxiliary propeller(s). Operation of the propellers may be controlled by independently varying rotational speeds and/or blade pitches thereof.

The control unit may be configured to be communicatively coupled to a remote control unit such that the control unit is capable of receiving control instructions from the remote control unit and control operation of the lift propeller and the auxiliary propeller(s) based on the control instructions. The control unit may be communicatively coupled to the sensors and/or the GPS module and may be configured to control operation of the propellers at least partially based on data received from the sensors and GPS module.

The drive arrangement may include a prime mover drivingly connected to one or more of the propellers. In a preferred embodiment of the invention, the drive arrangement includes an electric motor drivingly connected to each of the propellers.

The UAV may include at least one battery for powering the electric motors.

### BRIEF DESCRIPTION OF THE DRAWINGS

The invention will now be further described, by way of example, with reference to the accompanying conceptual drawings.

In the drawings:

FIG. 1 shows a three-dimensional view of an embodiment of a UAV according to the invention;

FIG. 2 shows another three-dimensional view of the UAV of FIG. 1;

FIG. 3 shows a front view of the UAV of FIG. 1;

FIG. 4 shows a side view of the UAV of FIG. 1;

FIG. 5 shows a top view of the UAV of FIG. 1; and

FIG. 6 shows a bottom view of the UAV of FIG. 1.

### DETAILED DESCRIPTION OF AN EXAMPLE EMBODIMENT

The following description of the invention is provided as an enabling teaching of the invention. Those skilled in the relevant art will recognise that many changes can be made to the embodiment described, while still attaining the beneficial results of the present invention. It will also be apparent that some of the desired benefits of the present invention can be attained by selecting some of the features of the present invention without utilizing other features. Accordingly, those skilled in the art will recognise that modifications and adaptations to the present invention are possible and can even be desirable in certain circumstances and are a part of the present invention. Thus, the following description is provided as illustrative of the principles of the present invention and not a limitation thereof.

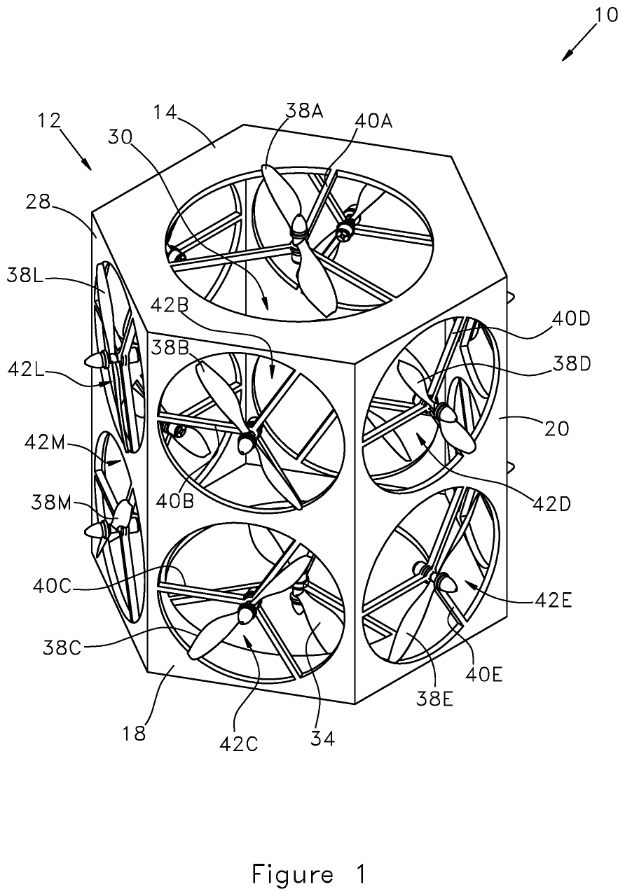

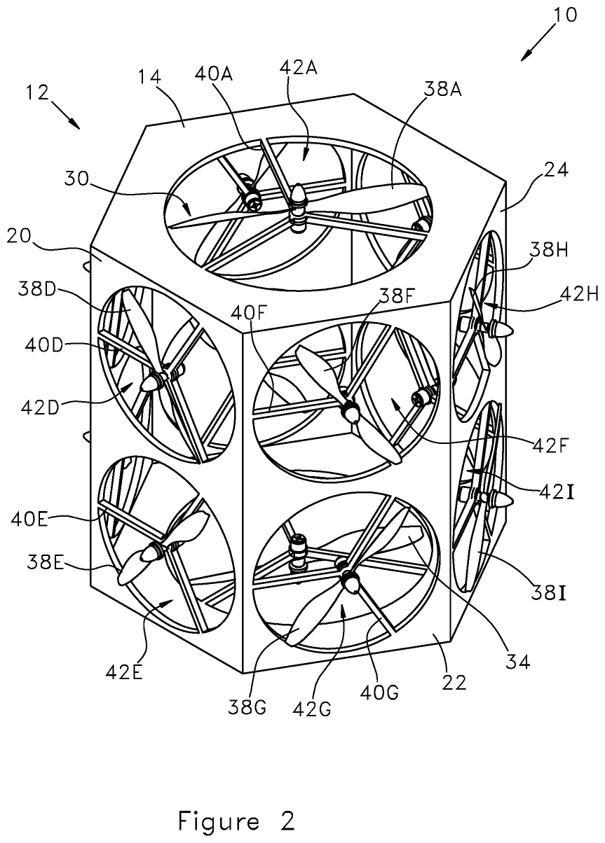

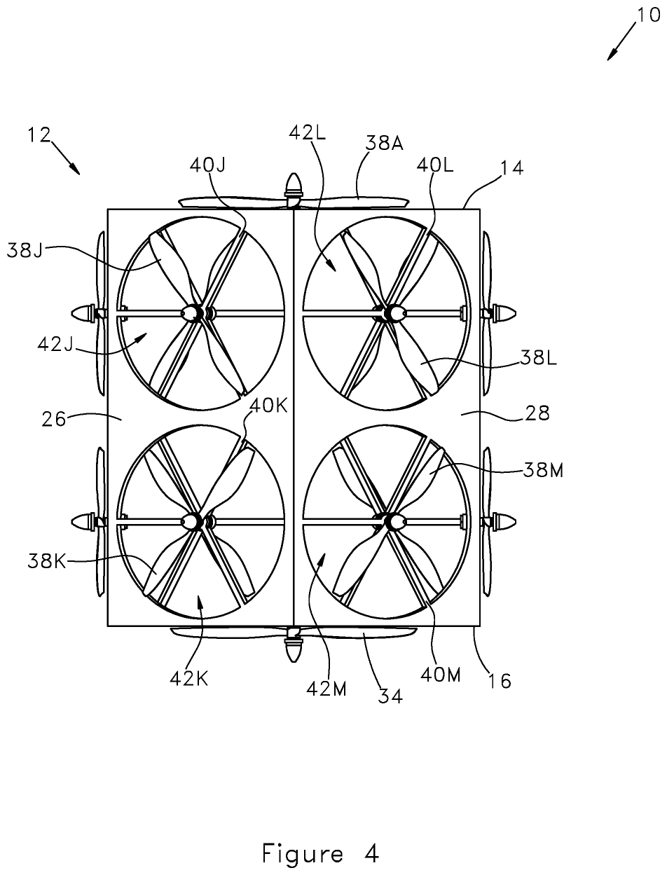

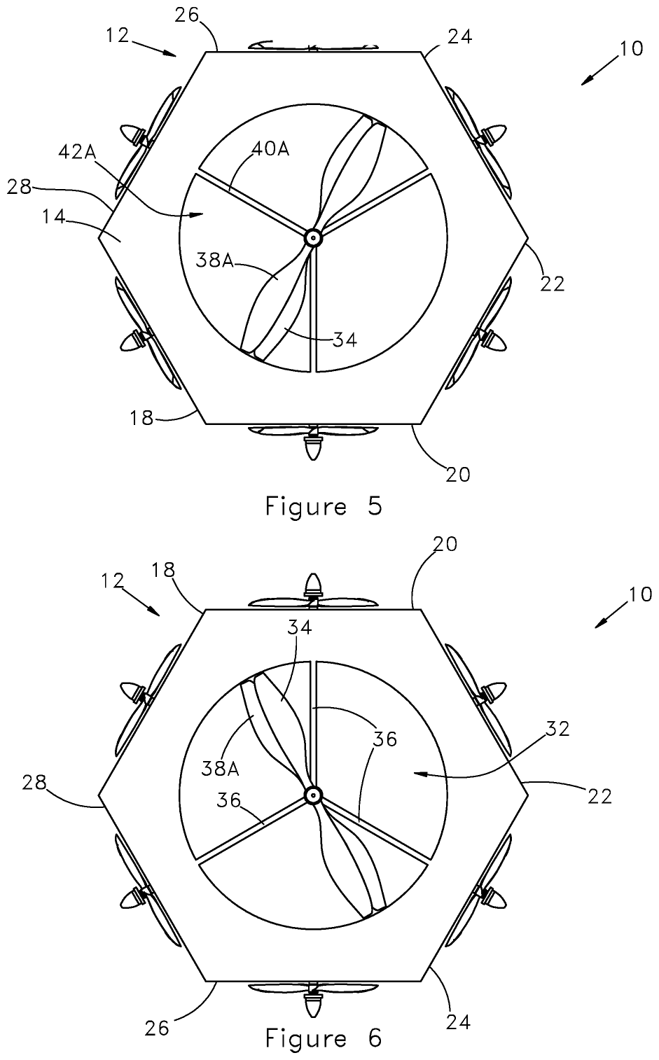

In FIGS. 1 to 6, reference numeral 10 indicates an embodiment of a rotary-wing UAV according to the invention.

The UAV 10 has an elongate body 12 in the shape of a hexagonal prism. The body 12 has a flat top end 14, a flat bottom end 16 and six flat sides 18, 20, 22, 24, 26, 28. The body 12 is hollow and defines an internal cavity 30.

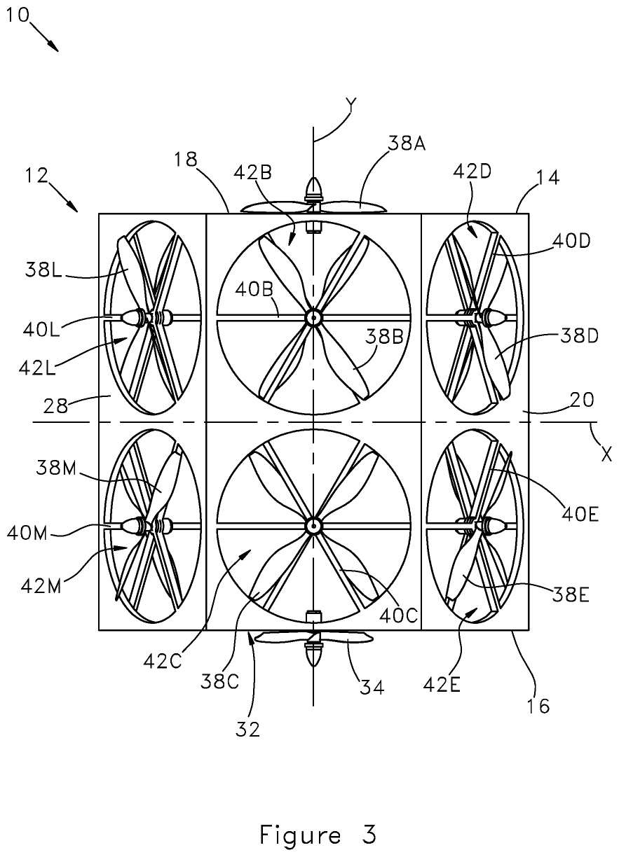

A longitudinal, operatively vertical axis “Y” and a transverse, operatively horizontal axis “X” of the UAV 10 are indicated in FIG. 3.

An exhaust arrangement, consisting of a circular exhaust opening 32 and a lift propeller 34, is provided at the bottom end 16 of the body 12. The lift propeller 34 is rotatably mounted to the body 12 by a mounting arrangement 36 located in the exhaust opening 32. The mounting arrangement 36 includes three thin arms extending outwardly and in an equiangular manner from a central portion which is aligned with a center point of the exhaust opening 32.

The lift propeller 34 has a blade diameter which is slightly less than a diameter of the exhaust opening 32 and the lift propeller 34 is configured to rotate about the axis Y, which extends through the center point of the exhaust opening 32.

The exhaust opening 32 is in fluid communication with the internal cavity 30 and the lift propeller 34 is configured such that rotation thereof causes air to be urged out of the internal cavity 30 via the exhaust opening 32 in an operatively downwardly direction, thus generating thrust/lift.

The UAV 10 further includes a pressuring arrangement in the form of a plurality of auxiliary propellers 38A-38M located operatively above the lift propeller 34. Each auxiliary propeller 38A-38M is rotatably mounted to the body 12 by a mounting arrangement 40A-40M located in a corresponding circular inlet 42A-42M in the body 12. The inlets 42A-42M are in fluid communication with the internal cavity 30 and the auxiliary propellers 38A-38M are configured to urge air through the inlets 42A-42M and into the internal cavity 30.

The auxiliary propeller 38A, inlet 42A and mounting arrangement 40A are structurally identical to the lift propeller 34, the exhaust opening 32 and the mounting arrangement 36, respectively.

The auxiliary propellers 38B-38M, inlets 42B-42M and mounting arrangements 40B-40M are similarly shaped to the lift propeller 34, the exhaust opening 32 and the mounting arrangement 36, respectively, but all have a slightly smaller diameter.

The auxiliary propellers 38A-38M are configured to rotate about center points of their corresponding inlets 42A-42M and each have a slightly smaller blade diameter than the diameter of the corresponding inlet 42A-42M.

The auxiliary propeller 38A is located at the top end 14 of the body 12 and is configured to rotate about the axis Y. The other auxiliary propellers 38B-38M are located at the sides 18, 20, 22, 24, 26, 28 of the body 12. Each side 18, 20, 22, 24, 26, 28 of the body 12 is provided with two vertically spaced apart auxiliary propellers 38B-38M configured to rotate about axes in planes parallel to the axis X.

The auxiliary propeller 38A operatively urges air vertically into the internal cavity 30, while the auxiliary propellers 38B-38M urge air horizontally into the internal cavity 30. The auxiliary propeller 38A additionally creates a low pressure zone above the drone or UAV thus providing additional lift.

In use, the auxiliary propellers 38A-38M serve to force air into the internal cavity 30, creating a high pressure zone in the internal cavity 30, i.e. a zone in which the air pressure is higher than the ambient or atmospheric air pressure outside of the UAV 10. The Inventor believes that this may cause the lift propeller 34 to generate greater lift without requiring the addition of extra propellers spaced apart along a horizontal plane in which the axis X of the UAV 10 lies.

In the embodiment shown, the propellers are shown to be positioned just outside the outer surface of the body. It will be appreciated that by varying the configuration of the mounting arrangements, the propellers can be positioned to optimize airflow through the associated inlets 42A-42M and/or the exhaust opening 32, e.g. in the associated inlet or exhaust opening. Further, if required suitable ducting may be provided to optimize the airflow through the inlets 42A-42M and/or the exhaust opening 32.

The invention thus provides a rotary-wing UAV which can be used to carry a payload in confined spaces and which provides increased lifting capability, while substantially minimizing the horizontal span of the UAV. The Inventor has also found that the high pressure zone created in embodiments of the present invention may serve to reduce or obviate the risk of vacuums forming above the lift propeller(s) which would define the point at which the maximum lift will be achievable of a UAV during operation.

The UAV 10 of FIGS. 1 to 6 is conceptually illustrated and, although not shown in the drawings, it will be understood by those of ordinary skill in the art that the UAV 10 will typically include a suitable control arrangement, driving arrangement and power source.

“Control arrangement” refers to the parts of the UAV 10 configured to provide or facilitate directional control of the UAV 10, in use. For instance, the auxiliary propellers 38B-38M may be configured to generate operative horizontal motion, tilt and/or angular displacement of the UAV 10. Angular displacement of the UAV 10 about the axis Y may be provided through control of the lift propeller 34 and the auxiliary propeller 38A mounted to the top end 14 of the body 12.

The control arrangement typically includes a suitable on-board control unit configured to control operation of the propellers 34, 38A-38M. One aspect of the operation of the propellers 34, 38A-38M may include independently varying rotational speeds of the propellers 34, 38A-38M in order to generate the required lift, motion, tilt, and the like. Instead or in addition, the pitch of the propeller blades may be adjustable.

The UAV 10 can be remotely controlled through control signals received from a remote control unit and/or can be controlled fully by the on-board control unit. The UAV 10 may thus include a suitable receiver, e.g. a radio receiver unit. The control unit can also be communicatively coupled to on-board sensors (e.g. a LIDAR sensor, gyroscope, accelerometer, and/or inertial measurement unit (IMU)) and a GPS module for controlling operation of the propellers 34, 38A-38M at least partially based on data relating to the position, orientation, motion and/or operating environment of the UAV 10.

“Drive arrangement” refers to the component or components causing rotation of the propellers 34, 38A-38M. It is envisaged that the drive arrangement may be provided by a dedicated electric motor drivingly connected to each one of the propellers 34, 38A-38M.

The power source may be one or more batteries, e.g. a rechargeable lithium-ion battery.

1-25. (canceled)

26. A rotary-wing unmanned aerial vehicle (UAV) which includes:
a body having an operative top and an operative bottom, the body defining an elongate internal cavity;
an exhaust arrangement provided at or near the bottom end, the exhaust arrangement including an operatively downwardly open exhaust opening in fluid communication with the internal cavity and at least one lift propeller configured to urge air out of the internal cavity via the exhaust opening;
a pressurising arrangement including at least two auxiliary propellers, the auxiliary propellers being configured to urge air transversely into the internal cavity at longitudinally spaced apart positions in order to increase air pressure in the internal cavity; and
a drive arrangement for driving the propellers.

27. The UAV as claimed in claim 26, in which the body defines a longitudinal or operatively vertical axis and a transverse or operatively horizontal axis, the lift propeller or propellers being configured to rotate about the longitudinal axis or an axis on a plane substantially parallel to the longitudinal axis, the pressurising arrangement being located operatively above the exhaust arrangement.

28. The UAV as claimed in claim 26, in which the lift propeller is mounted to the bottom of the body, the exhaust opening being generally circular, with the lift propeller being located in the exhaust opening or mounted to the body by a mounting arrangement located in the exhaust opening.

29. The UAV as claimed in claim 28, in which the axis about which the lift propeller is configured to rotate extends through a centre point of the exhaust opening, the lift propeller having a blade diameter which is slightly smaller than the diameter of the exhaust opening.

30. The UAV as claimed in claim 26, which includes a plurality of lift propellers.

31. The UAV as claimed in claim 27, in which each auxiliary propeller is located in, or mounted to a mounting arrangement located in, a corresponding inlet of the body, which is in fluid communication with the internal cavity, the auxiliary propeller being configured to urge air into the internal cavity via the corresponding inlet.

32. The UAV as claimed in claim 31, in which at least two of the auxiliary propellers are mounted to a side of the body and are configured to rotate about the transverse axis or an axis in a plane substantially parallel to the transverse axis.

33. The UAV as claimed in claim 32 in which at least one auxiliary propeller is mounted to the top of the body and is configured to rotate about the longitudinal axis or an axis on a plane substantially parallel to the longitudinal axis.

34. The UAV as claimed in claim 31, in which each inlet opening is generally circular, the axis about which the associated auxiliary propeller is configured to rotate extending through a centre point of the inlet opening, the auxiliary propeller having a blade diameter that is slightly smaller than a diameter of the inlet opening.

35. The UAV as claimed in claim 34, in which the body has a substantially flat top and bottom and a plurality of substantially flat sides, the auxiliary openings being provided in the sides and/or the top of the body.

36. The UAV as claimed in claim 35, in which the body has the shape of polygon having a plurality of planar sides, each side of the body being provided with two auxiliary propellers, the auxiliary propellers of each side of the body being spaced-apart along the longitudinal axis.

37. The UAV as claimed in claimed claim 26, in which at least one auxiliary propeller is configured to provide directional control of the UAV in use.

38. The UAV as claimed in claim 37, in which the at least one auxiliary propeller is configured to generate operative horizontal motion, tilt and/or angular displacement of the UAV.

39. The UAV as claimed in claim 38, in which angular displacement of the UAV is provided through control of the lift propeller and an auxiliary propeller mounted to the top of the body.

40. The UAV as claimed in claim 26, in which the lift propeller and at least one auxiliary propeller are configured to be operated separately or in one or more groups.

41. The UAV as claimed in claim 26, which is provided with at least one sensor selected from the following group, a Lidar sensor, motion sensor, gyroscope, accelerometer, inertial measurement unit (IMU), thermal sensor, and/or a global positioning system (GPS) module, the UAV further including
a control unit configured to control operation of the lift propeller and the auxiliary propellers, operation of the propellers being controlled by independently varying rotational speeds and/or blade pitches thereof.

42. The UAV as claimed in claim 41, in which the control unit is configured to be communicatively coupled to a remote control unit such that the control unit is capable of receiving control instructions from the control unit and the control operation of the lift propeller and the auxiliary propeller(s) based on the control instructions.

43. The UAV as claimed in claim 42, in which the control unit is communicatively coupled to the sensors and GPS module and is configured to control operation of the propellers, at least partially based on data received from the sensors and/or the GPS module.

44. The UAV as claimed in claim 26, in which the drive arrangement includes a prime mover drivingly connected to one or more of the propellers.

45. The UAV as claimed in claim 44, in which the drive arrangement includes an electric motor drivingly connected to each of the propellers, the UAV including a battery for powering the electric motors.
